(19) United States
(12) Patent Application Publication
(10) Pub. No.: US 2020/0402268 A1
(43) Pub. Date: Dec. 24, 2020

(54) DRIVING SUPPORT DEVICE, DRIVING SUPPORT METHOD, AND STORAGE MEDIUM STORING DRIVING SUPPORT PROGRAM

(71) Applicant: Mitsubishi Electric Corporation, Tokyo (JP)

(72) Inventor: Jumpei HATO, Tokyo (JP)

(73) Assignee: Mitsubishi Electric Corporation, Tokyo (JP)

(21) Appl. No.: 17/013,253

(22) Filed: Sep. 4, 2020

Related U.S. Application Data
(63) Continuation of application No. PCT/JP2018/009433, filed on Mar. 12, 2018.

(51) Int. Cl. G06T 11/00; G08G 1/16; G06K 9/00; G06T 3/20; B60K 35/00

(52) U.S. Cl. CPC G06T 11/00; G08G 1/167; G06K 9/00791; B60K 2370/21; B60K 35/00; B60K 2370/191; G06T 3/20

(57) ABSTRACT

A driving support device for supporting driving performed by a driver of a vehicle, includes processing circuitry to judge a target object that is a real object existing in a vicinity of the vehicle and should be paid attention to by the driver, based on vicinity information acquired by a vicinity detector that captures an image of or detects a real object existing in the vicinity of the vehicle; to generate a visual attraction stimulation image that appears to move from a position farther than the target object towards a position where the target object exists; and to cause a display device that displays an image in superimposition on the real object to display the visual attraction stimulation image.

### CROSS-REFERENCE TO RELATED APPLICATION

This application is a continuation application of International Application No. PCT/JP2018/009433 having an international filing date of Mar. 12, 2018, which is hereby expressly incorporated by reference into the present application.

### BACKGROUND OF THE INVENTION

### 1. Field of the Invention

The present invention relates to a driving support device, a driving support method and a storage medium storing a driving support program for presenting a driver of a vehicle with a visual attraction stimulation image that appears to move from a position farther than a target object existing in the vicinity of the vehicle towards the position of the target object.

### 2. Description of the Related Art

There has been proposed a device that explicitly guides the line of sight of a driver of a vehicle to a target object as an obstacle existing in the vicinity of the vehicle by displaying an enhanced image in superimposition on the target object depending on the driver's awareness level (see Patent Reference 1, for example).

There has also been proposed a device that carries out sight line guidance without making a driver of a vehicle be conscious of the sight line guidance by guiding the driver's line of sight by use of a stimulus (e.g., luminance image) that is hardly distinguishable from a visual attraction target object existing in the vicinity of the vehicle (see Patent Reference 2, for example).

Incidentally, in the present application, “visual attraction” means attracting a person's line of sight. Further, “visual attractiveness” means the degree of attracting attention of a person, which is referred to also as attention-drawing quality. Furthermore, “visual attractiveness is high” means that the ability to attract a person's line of sight is high, which is referred to also as “conspicuous”.

Patent Reference 1: Japanese Patent Application Publication No. 7-061257 (paragraphs 0004 to 0008, for example)

Patent Reference 2: Japanese Patent Application Publication No. 2014-099105 (paragraphs 0039 and 0058, for example)

With the device described in the Patent Reference 1, the enhanced image is displayed in superimposition on the target object that is a real object, and thus the driver strongly recognizes the fact that the driver underwent the sight line guidance, and consequently, a situation in which the driver is overconfident in the driver's own attentiveness is unlikely to occur. However, continuous use of this device is accompanied by the danger that the driver loses consciousness trying to perceive the target object with the driver's own attentiveness.

With the device described in the Patent Reference 2, the luminance image is displayed in superimposition on the visual attraction target object, and thus there is the danger that the driver loses the consciousness trying to perceive the target object with the driver's own attentiveness. Further, since the driver's line of sight is guided by using the luminance image hardly distinguishable from the visual attraction target object, there tends to occur a situation in which the driver recognizes that the driver perceived the target object with the driver's own attentiveness alone (i.e., the driver erroneously assumes that the driver perceived the target object with the driver's own attentiveness alone) and the driver becomes overconfident in the driver's own attentiveness. If the driver becomes overconfident in the driver's own attentiveness, the driver's consciousness trying to perceive the target object with the driver's own attentiveness lowers.

### SUMMARY OF THE INVENTION

An object of the present invention, which has been made to resolve the above-described problems, is to provide a driving support device, a driving support method and a driving support program capable of guiding the line of sight of the driver of a vehicle to a target object and preventing the lowering of the driver's consciousness trying to perceive the target object with the driver's own attentiveness.

A driving support device according to the present invention is a device for supporting driving performed by a driver of a vehicle, including processing circuitry to judge a target object that is a real object existing in a vicinity of the vehicle and should be paid attention to by the driver, based on vicinity information acquired by a vicinity detector that captures an image of or detects a real object existing in the vicinity of the vehicle; to generate a visual attraction stimulation image that appears to move from a position farther than the target object towards a position where the target object exists; and to cause a display device that displays an image in superimposition on the real object to display the visual attraction stimulation image, wherein the processing circuitry sets a direction of a movement vector of the visual attraction stimulation image in regard to a time of determining the position of starting the movement of the visual attraction stimulation image at a direction heading towards a position of the vehicle.

According to the present invention, the line of sight of the driver of the vehicle can be guided to the target object and the lowering of the driver's consciousness trying to perceive the target object with the driver's own attentiveness can be prevented.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a diagram showing a hardware configuration of a driving support device according to an embodiment of the present invention;

FIG. 2 is a diagram showing an example of a state in which a driver is using the driving support device according to the embodiment;

FIG. 3 is a diagram showing a case where a display device for displaying a visual attraction stimulation image generated by the driving support device according to the embodiment is a projector of a HUD;

FIG. 4 is a diagram showing a case where the display device for displaying the visual attraction stimulation image generated by the driving support device according to the embodiment is AR glasses of an HMD;

FIG. 5 is a functional block diagram showing the driving support device according to the embodiment;

FIG. 6 is a flowchart showing the operation of a target object judgment unit of the driving support device according to the embodiment;

FIG. 7 is a flowchart showing the operation of a visual attraction stimulation image generation unit of the driving support device according to the embodiment;

FIG. 8 is a flowchart showing a process of generating a new visual attraction stimulation plan performed by the visual attraction stimulation image generation unit of the driving support device according to the embodiment;

FIG. 9 is an explanatory diagram showing a process of generating the visual attraction stimulation plan performed by the visual attraction stimulation image generation unit of the driving support device according to the embodiment;

FIG. 10 is an explanatory diagram showing weights used in a visual attraction stimulation plan generation process performed by the visual attraction stimulation image generation unit of the driving support device according to the embodiment;

FIG. 11 is a flowchart showing an existing visual attraction stimulation plan correction process performed by the visual attraction stimulation image generation unit of the driving support device according to the embodiment;

FIG. 12 is a flowchart showing a visual attraction stimulation frame generation process performed by the visual attraction stimulation image generation unit of the driving support device according to the embodiment;

FIG. 13 is a diagram showing a state in which a pedestrian as a target object is walking on a sidewalk on a left-hand side and a vehicle is traveling on a right-hand lane of a roadway;

FIGS. 14A to 14E are diagrams showing an example of the visual attraction stimulation images displayed by the driving support device according to the embodiment;

FIGS. 15A to 15E are diagrams showing another example of the visual attraction stimulation images displayed by the driving support device according to the embodiment; and

FIGS. 16A to 16E are diagrams showing another example of the visual attraction stimulation images displayed by the driving support device according to the embodiment.

### DETAILED DESCRIPTION OF THE INVENTION

A driving support device, a driving support method and a driving support program according to an embodiment of the present invention will be described below with reference to the accompanying drawings. The following embodiment is just an example and a variety of modifications are possible within the scope of the present invention.

### (1) Configuration

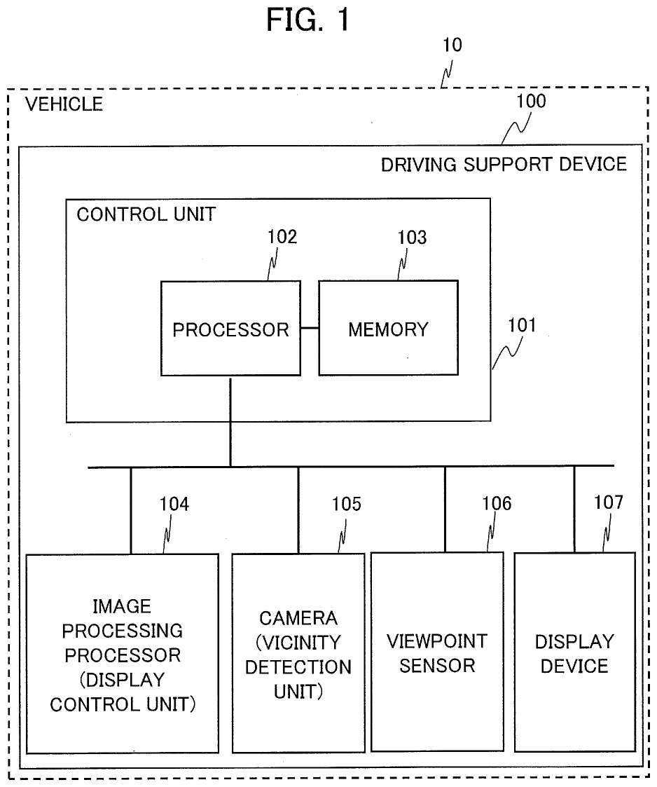

FIG. 1 is a diagram showing a hardware configuration of a driving support device 100 according to an embodiment of the present invention. The driving support device 100 is a device capable of executing a driving support method according to the embodiment. As shown in FIG. 1, the driving support device 100 includes a control unit 101. The driving support device 100 is a device that visually presents a visual attraction stimulation image, for guiding the line of sight of a driver of a vehicle 10 (i.e., host vehicle), to the driver so as to make it possible to perform sight line guidance for making the driver perceive a target object that is a real object existing in the vicinity of the vehicle 10 and prevent the lowering of the driver's consciousness trying to perceive the target object with the driver's own attentiveness.

The control unit 101 includes a processor 102 as an information processing unit and a memory 103 as a storage unit or a non-transitory computer-readable storage medium storing necessary data and programs. For example, the processor 102 is capable of implementing the operation of the driving support device 100 by executing a driving support program stored in the memory 103. The control unit 101 and an image processing processor 104 may also be implemented as a part of a computer. The driving support device 100 may include processing circuitry that can implement the operation of the driving support device shown in FIG. 1.

The driving support device 100 further includes the image processing processor 104 as a display control unit, a camera 105 as a vicinity detection unit that acquires vicinity information regarding the vicinity of the vehicle 10, and a display device 107 that presents an image to the driver. The vicinity information is, for example, information on a scene in front of the vehicle, such as an image of the scene in front of the vehicle 10 (hereinafter referred to also as a “forward image”) captured by the camera 105. The driving support device 100 may include a viewpoint sensor 106 that detects a viewpoint position or the line of sight of the driver in the vehicle 10. Incidentally, the “viewpoint” is a point at which the line of sight oriented to view an object is cast. The “line of sight” is a line connecting the center of the eyes and the viewed object.

The camera 105, as a camera for capturing images of the outside of the vehicle, captures an image (which can also mean video) including a real object outside the vehicle 10 and transfers the acquired image data in a format that can be processed by the processor 102. The image data may include distance data indicating the distance from the vehicle 10 to the real object. Alternatively, the processor 102 may figure out the distance data by analyzing the image data. Incidentally, the vicinity detection unit as a vicinity detector may include a sensor such as a radar for detecting the real object in the vicinity of the vehicle 10 in addition to the camera 105 or instead of the camera 105.

The display device 107 is a display apparatus that displays each image frame generated by the processor 102 and the image processing processor 104 to be visually recognizable by the driver of the vehicle 10. The driver of the vehicle 10 can view the image frame displayed by the display device 107 (including the visual attraction stimulation image) in superimposition with the real scene perceived through the windshield (i.e., windscreen) of the vehicle 10.

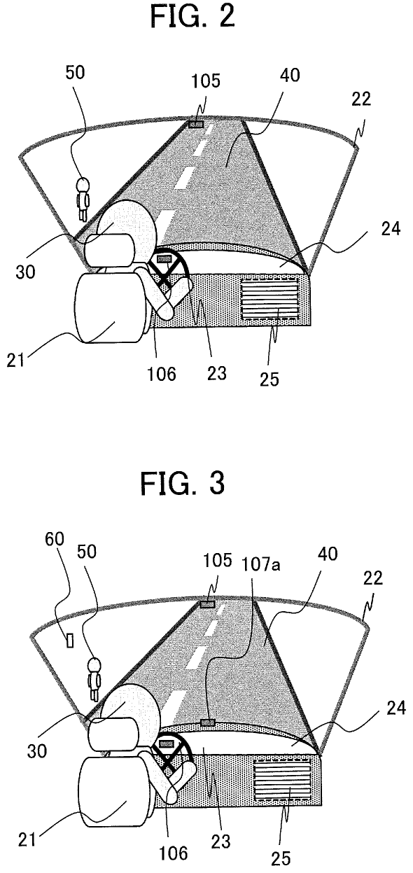

FIG. 2 is a diagram showing an example of a state in which the driver 30 of the vehicle 10 is using the driving support device 100 according to the embodiment. FIG. 2 shows a state in which the driver 30 seated on a driver seat 21 is driving the vehicle 10. In the example of FIG. 2, the driver 30 is viewing the scene in front of the vehicle 10 through the windshield 22, and a road 40 and a real object (a pedestrian as a target object 50 in FIG. 2) are visible to the driver 30. The camera 105 for capturing images of the scene in front of the vehicle 10 is set at a position in the vicinity of the top center of the windshield 22, for example. In general, the camera 105 is placed to be able to capture an image close to the scene the driver 30 is viewing through the windshield 22.

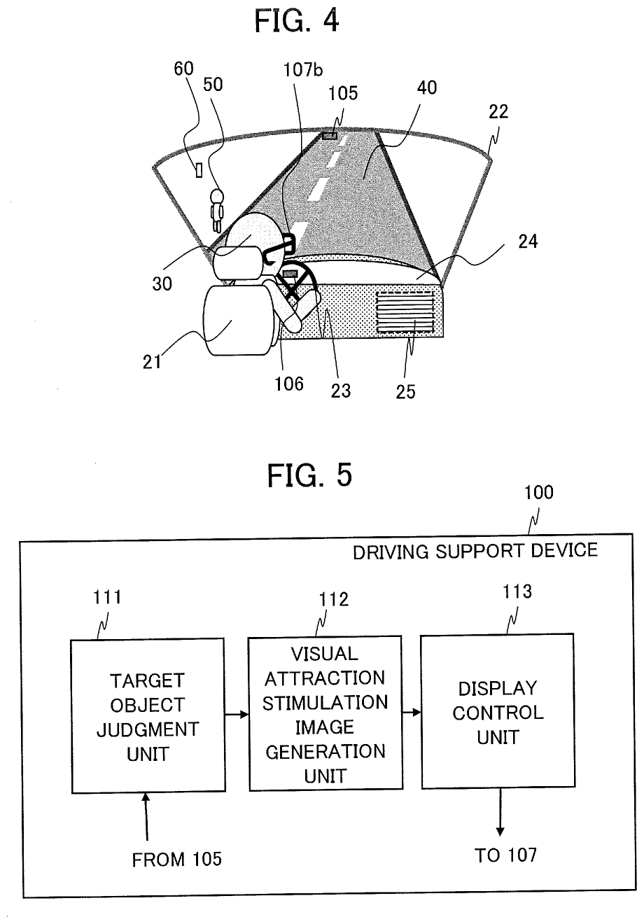

Further, the viewpoint sensor 106 is set at a position where the face, especially the eyes, of the driver 30 can be detected. The viewpoint sensor 106 may be set on a steering wheel 23, an instrument panel 24 or the like, for example. The processor 102, the memory 103 and the image processing processor 104 shown in FIG. 1 may be set inside a dashboard 25 or the like. The processing by the image processing processor 104 may be executed by the processor 102. The display device 107 is not shown in FIG. 2. The display device 107 is illustrated in FIG. 3 and FIG. 4. Incidentally, while FIG. 2 to FIG. 4 illustrate cases where the vehicle 10 has the steering wheel on the left-hand side and is traveling forward on a right-hand lane of the road 40, the structure of the vehicle 10, the driving lane and the shape of the road 40 are not limited to the examples shown in the diagrams.

FIG. 3 is a diagram showing a case where the display device for displaying the visual attraction stimulation image 60 generated by the driving support device 100 according to the embodiment is a projector 107a of a HUD (Head Up Display). In the example of FIG. 3, the projector 107a is arranged on the dashboard 25. The image frame projected by the projector 107a (including the visual attraction stimulation image 60) is projected onto a projection surface provided on the entire windshield 22 to be viewed by the driver 30. The driver 30 can view the image frame projected by the projector 107a in superimposition with the scene (including the real object) viewed through the windshield 22.

FIG. 4 is a diagram showing a case where the display device for displaying the visual attraction stimulation image 60 generated by the driving support device 100 according to the embodiment is AR (Augmented Reality) glasses 107b (e.g., glasses for augmented reality images) of an HMD (Head Mounted Display). In the example of FIG. 4, the driver 30 can view the image frame (including the visual attraction stimulation image 60) by wearing the AR glasses 107b. The driver 30 can view the image frame displayed by the AR glasses 107b in superimposition with the scene (including the real object) viewed through the windshield 22.

FIG. 5 is a functional block diagram showing the driving support device 100 according to the embodiment. As shown in FIG. 5, the driving support device 100 includes a target object judgment unit 111, a visual attraction stimulation image generation unit 112 and a display control unit 113. In order to support the driving performed by the driver 30 of the vehicle 10, the driving support device 100 makes the display device 107 display the visual attraction stimulation image 60 and gradually guides the line of sight of the driver 30 towards the target object by use of the visual attraction stimulation image 60.

The target object judgment unit 111 judges the target object 50, that is, a real object existing in the vicinity of the vehicle 10 and should be paid attention to by the driver 30, based on the vicinity information acquired by the camera 105 as the vicinity detection unit for capturing an image of or detecting a real object existing in the vicinity of the vehicle 10. The target object 50 is a real object (specifically, a moving object) existing in the vicinity of the vehicle and should be paid attention to by the driver 30. For example, the target object 50 is a real object that the vehicle 10 should avoid colliding with, such as a human, another vehicle or an animal. The target object 50 is not limited to a moving object. However, the target object judgment unit 111 may select the target object 50 while limiting the target object 50 to a moving object.

The visual attraction stimulation image generation unit 112 generates the visual attraction stimulation image 60 that appears to move from a position farther than the target object 50 towards a position where the target object 50 exists. The display control unit 113 makes the display device 107 display the visual attraction stimulation image 60 as an image that appears to be in superimposition with the target object 50 being a real object.

### (2) Operation

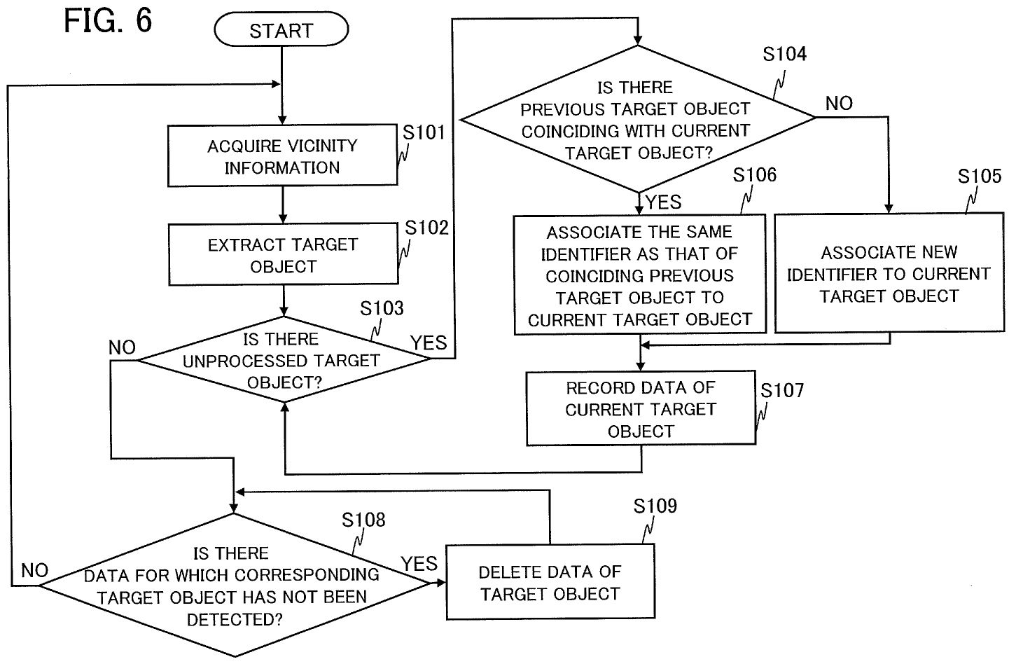

The operation of the driving support device 100 (i.e., the driving support method) according to the embodiment will be described below. FIG. 6 is a flowchart showing the operation of the target object judgment unit 111. A flow of process shown in FIG. 6 is executed repeatedly at predetermined time intervals during the traveling of the vehicle 10, for example.

First, in process step S101, the target object judgment unit 111 acquires the vicinity information indicating an image (including a real object) of the scene in front of the vehicle 10 captured by the camera 105 (i.e., the forward image), for example.

In the next process step S102, the target object judgment unit 111 performs an extraction process of extracting a real object that can be a target object from the forward image. The extracted real object is, for example, a moving real object such as a human, another vehicle or an animal. Means for extracting the real object from the forward image can be implemented by employing a known technology such as the computer vision technology in regard to the technology of acquiring information on the real world and the technology of recognizing an object. When there exist a plurality of extracted real objects, it is desirable to handle only one or some real objects having high priority among the plurality of real objects as the target object(s) 50 as the target(s) of generating the visual attraction stimulation image 60 (i.e., to perform the narrowing down so as to specify only one or more real objects among the plurality of real objects as the target object(s) 50) in order to reduce the processing load on the control unit 101 of the driving support device 100 and reduce the load on the driver 30.

The target object 50 satisfies one of the following first to fifth conditions, for example:

(First Condition) A real object whose probability of collision with the vehicle 10 is greater than or equal to a predetermined certain value.
(Second Condition) A real object whose distance from the vehicle 10 is less than or equal to a predetermined certain value.
(Third Condition) A real object moving towards the vehicle 10 and having a moving speed greater than or equal to a predetermined certain value.
(Fourth Condition) A real object judged not to have been perceived by the driver 30 yet based on the result of detection by the viewpoint sensor 106.
(Fifth Condition) A real object satisfying a combination of two or more conditions among the first to fourth conditions.

It is also possible to assign priority to each of the first to fourth conditions. Further, it is possible to judge that the priority of a moving object satisfying a greater number of conditions among the first to fourth conditions is higher. It is also possible to set the priority in the order of a human, another vehicle and an animal, for example. It is also possible to select a predetermined number of real objects having high priority as the target objects from real objects satisfying a predetermined condition.

Information on each target object 50 extracted in the process step S102 includes, for example, target object region information indicating a region occupied by the target object 50 in the image captured by the camera 105, target object distance information indicating the distance from the vehicle 10 to the target object 50, and target object barycentric coordinate information indicating the barycenter position of the target object. The number of target objects 50 may be two or more.

In process step S103, the target object judgment unit 111 judges whether or not each target object 50 extracted in the process step S102 is a target object on which processing of process steps S104-S107 has already been performed. Namely, when a plurality of target objects 50 are processed successively, the target object judgment unit 111 judges whether or not each target object 50 is a processed target object or an unprocessed target object. The target object judgment unit 111 advances the process to process step S108 when every target object 50 is a processed target object, or to process step S104 when a target object 50 is an unprocessed target object.

In the process step S104, the target object judgment unit 111 judges whether or not the current target object as the target object 50 currently being the processing target coincides with a previous target object as a target object extracted before the current target object. At that time, information on each previous target object is acquired from target object data recorded in the memory 103 in the process step S107 regarding the previous target object. The target object judgment unit 111 advances the process to process step S105 when there is no previous target object coinciding with the current target object, or to process step S106 when there is a previous target object coinciding with the current target object.

In the process step S105, the target object judgment unit 111 performs a process of associating a new identifier for uniquely identifying the new target object being the current target object, to the current target object.

In the process step S106, the target object judgment unit 111 performs a process of associating an identifier for uniquely identifying the current target object (i.e., an identifier of the coinciding previous target object) to the current target object.

In the process step S107, the target object judgment unit 111 records the target object data indicating the target object 50 in the memory 103. The target object data includes, for example, the identifier associated in the process step S105 or S106, the image data of the scene in front of the vehicle 10 including the target object 50, distance data indicating the distance to the target object 50, data indicating the region occupied by the target object 50, the barycentric coordinates of the target object 50, the priority of the target object 50, and so forth. Further, the target object data includes various types of flag data that become necessary in other processes or various types of parameters that become necessary in other processes, for example. The flag data may include, for example, an already-viewed flag (which is off as an initial value) indicating the existence/nonexistence of the target object data, a display completion flag (which is off as an initial value) indicating whether the visual attraction stimulation image has been displayed or not, or the like. After completing the recording in the process step S107, the target object judgment unit 111 returns the process to the process step S103 and repeats the processing of the process steps S104 to S107 for each target object 50 existing in the same forward image.

The target object judgment unit 111 advances the process to the process step S108 when the processing for all the target objects 50 detected in the image acquired in the process step S101 is finished. In the process step S108, the target object judgment unit 111 judges whether or not there is a previous target object, among the recorded previous target objects, that coincided with no current target object. The target object judgment unit 111 advances the process to process step S109 when there is such a previous target object (YES in S108), or returns the process to the process step S101 when there is no such previous target object (NO in S108).

In the process step S109, the target object judgment unit 111 deletes the previous target object that coincided with no current target object from the memory 103 and removes unnecessary data regarding the deleted previous target object from the memory 103. After the process step S109, the target object judgment unit 111 advances the process to the process step S108.

However, the target object judgment unit 111 may also be configured not to carry out the deletion in the process step S109. This is because there are possibly cases where the extraction of the target objects 50 in the process step S102 cannot be performed correctly due to noise, restriction on the processing method, or the like. Further, the target object judgment unit 111 may delete unnecessary data from the memory 103 when the YES judgment in the process step S108 has been made for a predetermined number of times or more. The target object judgment unit 111 may also be configured to delete unnecessary data from the memory 103 after the passage of a predetermined certain time after the YES judgment in the process step S108.

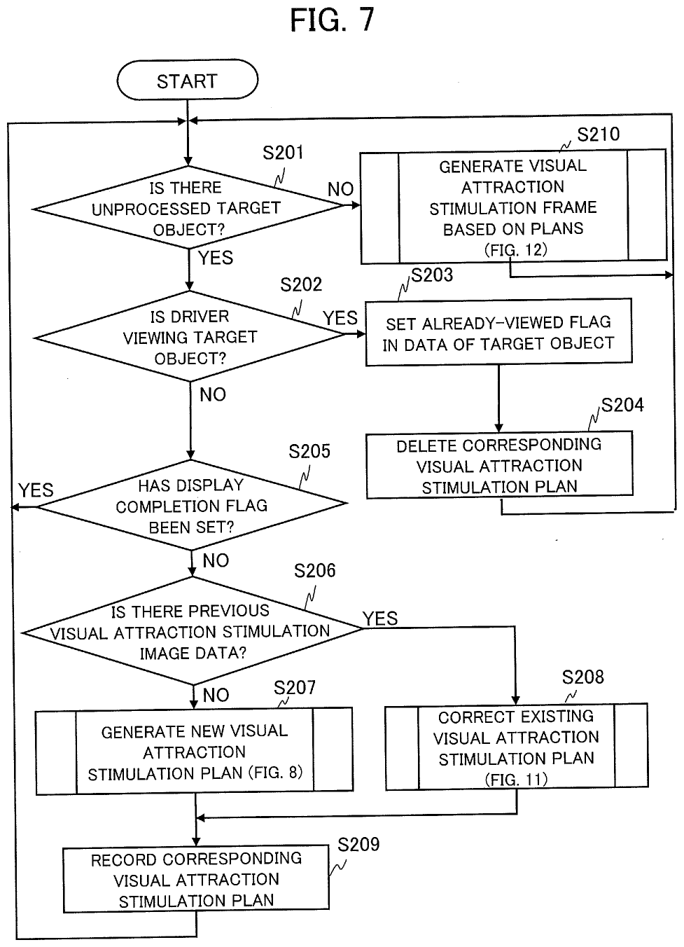

FIG. 7 is a flowchart showing the operation of the visual attraction stimulation image generation unit 112. The visual attraction stimulation image generation unit 112 generates or corrects (i.e., modifies) a visual attraction stimulation plan, as a plan regarding what kind of visual attraction stimulation image should be generated for each target object 50, based on the target object data regarding the target objects 50 extracted by the target object judgment unit 111, and generates a visual attraction stimulation frame including the visual attraction stimulation images.

In process step S201, the visual attraction stimulation image generation unit 112 judges whether or not there is target object data not processed yet by the visual attraction stimulation image generation unit 112 among the target object data recorded in the memory 103, that is, judges whether or not there is an unprocessed target object. The visual attraction stimulation image generation unit 112 advances the process to process step S202 when there is an unprocessed target object, or to process step S210 when there is no unprocessed target object.

In the process step S202, the visual attraction stimulation image generation unit 112 judges whether or not the driver 30 is viewing the target object 50. This judgment can be made based on whether the viewpoint overlaps with the target object region or not by using the viewpoint position and the line of sight of the driver 30 acquired by the viewpoint sensor 106 at a time closest to the time of the capture of the forward image by the camera 105, for example. In this case, it is assumed that parameters of the viewpoint sensor 106 and parameters of the camera 105 have previously been calibrated appropriately.

However, there can occur a situation in which the viewpoint overlaps with the target object region by accident due to movement of the line of sight of the driver 30. Therefore, the visual attraction stimulation image generation unit 112 may be configured to judge that the driver 30 is viewing the target object 50 when the state in which the viewpoint overlaps with the target object region continues for a predetermined certain time or longer. In this case, the time (i.e., duration time) for which the driver 30 viewed the target object 50 is additionally recorded as the target object data. Further, the visual attraction stimulation image generation unit 112 may also be configured to judge that the driver 30 is viewing the target object 50 when the already-viewed flag recorded as the target object data is on.

The visual attraction stimulation image generation unit 112 advances the process to process step S203 when the driver 30 is judged to be viewing the target object 50, or to process step S205 when the driver 30 is judged to be not viewing the target object 50.

In the process step S203, in order to indicate that the target object data of the target object 50 that the driver 30 is already viewing is target object data regarding an already-viewed target object 50, the visual attraction stimulation image generation unit 112 changes the already-viewed flag in the corresponding target object data to on, and thereafter advances the process to process step S204. However, even when the driver 30 is judged once to be viewing the target object 50, the level of recognition of the target object by the driver 30 thereafter drops with the passage of time of not viewing the target object. Therefore, the visual attraction stimulation image generation unit 112 may be configured to return the display completion flag to off and return the already-viewed flag to off when the time that passes from the judgment that the driver 30 is viewing the target object to the next judgment that the driver 30 is viewing the target object is longer than or equal to a predetermined certain time.

In the process step S204, the visual attraction stimulation image generation unit 112 deletes the visual attraction stimulation plan corresponding to the target object 50 whose already-viewed flag is on from the memory 103, determines not to generate the visual attraction stimulation image for this target object 50, and returns the process to the process step S201.

In the process step S205, the visual attraction stimulation image generation unit 112 judges whether or not the displaying of the visual attraction stimulation image 60 for the target object 50 has already been completed. The visual attraction stimulation image generation unit 112 judges that the displaying of the visual attraction stimulation image 60 has been completed if the display completion flag in the corresponding target object data is on, or judges that the displaying of the visual attraction stimulation image 60 has not been completed yet if the display completion flag is off. The visual attraction stimulation image generation unit 112 returns the process to the process step S201 if it is completed (YES in S205), or advances the process to process step S206 if it is not completed (NO in S205).

In the process step S206, the visual attraction stimulation image generation unit 112 judges whether or not the visual attraction stimulation plan corresponding to the target object 50 has already been generated. The visual attraction stimulation image generation unit 112 advances the process to process step S207 if the visual attraction stimulation plan has not been generated yet, or to process step S208 if the visual attraction stimulation plan has already been generated.

In the process step S207, the visual attraction stimulation image generation unit 112 performs a process of generating a new visual attraction stimulation plan for the target object 50 for which the visual attraction stimulation plan has not been generated yet.

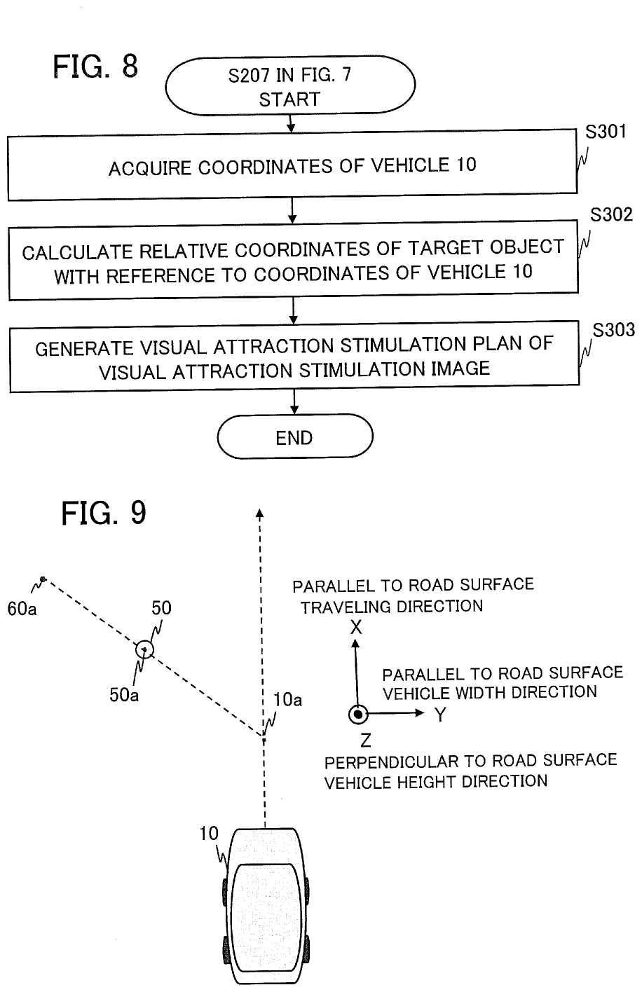

FIG. 8 is a flowchart showing the process of generating a new visual attraction stimulation plan in the process step S207. In process step S301, the visual attraction stimulation image generation unit 112 acquires the coordinates of the vehicle 10 driven by the driver 30. While the coordinates of the vehicle 10 may be coordinates in a global coordinate system obtained by using a GPS (Global Positioning System) or the like, the coordinates of the vehicle 10 may also be a position in a coordinate system defined with reference to the position of the driving support device 100. For example, a coordinate system in which the installation position of the camera 105 is set at reference coordinates (i.e., origin) may be used. It is also possible to set the barycenter position of the vehicle 10 at the reference coordinates, or to set the central position of the front bumper at the reference coordinates. Alternatively, it is also possible to set the barycentric coordinates of the vehicle 10 or the coordinates of the central position of the front bumper of the vehicle 10, situated at a position where the vehicle 10 is expected to exist at a time point (i.e., future time) after the passage of a predetermined certain time from the present time, at the reference coordinates.

In process step S302, the visual attraction stimulation image generation unit 112 performs a process of transforming the coordinates of the target object into coordinates in a coordinate system in which the driving support device 100 is placed at a reference position. The coordinate system in which the driving support device 100 is placed at the reference position is, for example, a coordinate system in which the installation position of the camera 105 is set at the origin. By this coordinate transformation, the coordinates of the target object 50 can be represented by coordinates in the same coordinate system as the coordinates of the vehicle 10.

In process step S303, the visual attraction stimulation image generation unit 112 generates the visual attraction stimulation plan as a plan regarding how the visual attraction stimulation image should be presented to the driver 30.

FIG. 9 is an explanatory diagram showing the process of generating the visual attraction stimulation plan performed by the visual attraction stimulation image generation unit 112. An XYZ coordinate system is shown in FIG. 9. The X-axis is a coordinate axis parallel to the road surface and oriented in a traveling direction of the vehicle 10. The Y-axis is a coordinate axis parallel to the road surface and oriented in a vehicle width direction of the vehicle 10. The Z-axis is a coordinate axis perpendicular to the road surface and oriented in a vehicle height direction of the vehicle 10.

The process of generating the visual attraction stimulation plan will be described below in regard to the example in which the target object 50 and the vehicle 10 exist. In the example of FIG. 9, coordinates 50a are target object coordinates as coordinates of the target object 50, and coordinates 10a are coordinates of the vehicle 10. The coordinates 10a are, for example, coordinates where the vehicle 10 is expected to exist at a time (T+T0) after the passage of a predetermined certain time T after the time T0 at which the visual attraction stimulation image is generated.

Coordinates 60a are coordinates representing an initial position of drawing the visual attraction stimulation image. The coordinates 60a are coordinates on a plane including a half line extending from the coordinates 10a of the vehicle 10 towards the coordinates 50a of the target object 50 and perpendicular to the ground (i.e., road surface). The height (i.e., Z-axis direction position) of the coordinates 60a is set to be equal to the Z-axis direction position of the coordinates 50a, for example. The coordinates 60a reach the coordinates 50a when the coordinates 60a move towards the coordinates 50a at a moving speed S for a movement time T1. The coordinates 60a are situated on a side opposite to the coordinates 10a with reference to the coordinates 50a. The coordinates 60a are initial coordinates of the visual attraction stimulation image.

The visual attraction stimulation image is presented as a visual stimulation image that moves from the coordinates 60a as a starting point towards the target object 50 at the moving speed S for the movement time T1. Further, the visual attraction stimulation image is presented as a visual stimulation image that is superimposed on the target object 50 for a superimposition time T2 after reaching the target object 50.

The moving speed S, the movement time T1 and the superimposition time T2, which can be predetermined fixed values, can also be variable values varying depending on the situation. For example, by setting the moving speed S to be higher than or equal to a lowest speed (lower limit speed) and lower than a highest speed (upper limit speed) perceivable as movement in the human's peripheral visual field, the movement can be perceived in the peripheral visual field of the driver 30 even when the driver 30 is not pointing the line of sight towards the vicinity of the target object.

Further, by setting the movement time T1 with reference to the human's visual reaction speed, it is possible to complete the superimposition on the target object 50 before the movement of the visual attraction stimulation image itself is perceived in the central visual field of the driver 30. In this case, it is possible to avoid presenting too much difference between stimulation given to the driver 30 by the visual attraction stimulation image and stimulation given to the driver 30 by the target object 50.

It is also possible to assign weights to parameters of the visual attraction stimulation image (e.g., the moving speed S, the movement time T1 and the superimposition time T2) according to the distance between the viewpoint position of the driver 30 and the coordinates of the target object 50 at each time point. For example, the weighting may be done so as to cause positive correlation between the distance to the target object 50 and the moving speed S or between the distance to the target object 50 and the movement time T1.

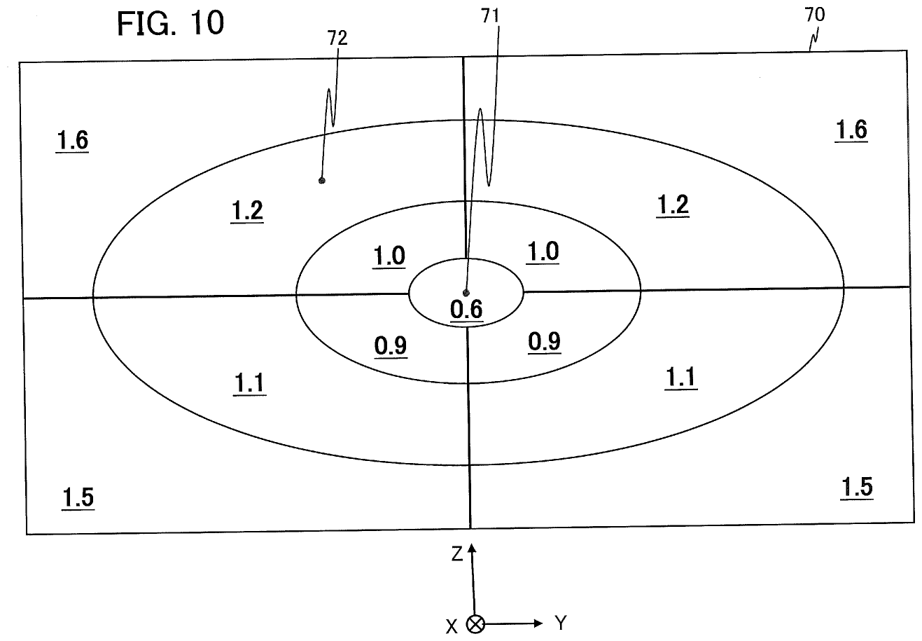

The weighting may also be done based on a viewpoint vector of the driver 30 at each time point. FIG. 10 is an explanatory diagram showing the viewpoint vector and a weight value for each spatial division region on a virtual plane 70 arranged right in front of the driver 30 and in parallel with the YZ plane. In FIG. 10, the viewpoint vector of the driver 30 becomes a perpendicular line to the plane 70 when the viewpoint vector crosses a point 71. While various methods can be employed as the method of dividing space into regions, the division in the example of FIG. 10 is carried out by setting a plurality of concentric ellipses centering at the point 71 each having a radius in the horizontal direction longer than a radius in the vertical direction and by using a horizontal line and a vertical line passing through the point 71. The weight value described in a region including a point 72 where a line segment connecting the coordinates of the target object 50 and the eye position of the driver 30 intersects with the plane 70 is used for weighting calculation in the calculation of the parameters. In FIG. 10, the weight value is determined as 1.2 and the values of the moving speed S and the movement time T1 are changed according to the weight value (e.g., in proportion to the weight value).

It is also possible to determine the weight value to suit personal characteristics of the driver 30 since those parameters vary depending on the characteristics of each person as the driver 30. Further, since even the parameters for each person vary depending on physical condition or the like, it is also possible to employ a biological sensor and change the weight value according to condition of the driver 30 detected based on the result of detection by the biological sensor.

Especially, parameters like the speed limits are sensory parameters as viewed from the driver 30's eye, and thus such parameters may be determined after temporarily transforming the coordinate system into a coordinate system in which coordinates of the driver 30's eye are placed at the origin. The coordinates of the driver 30's eye in that case may be transformed by using data acquired from the viewpoint sensor 106 and relative positions of the viewpoint sensor 106 and the camera 105.

Next, specific contents of the visual attraction stimulation image will be described below. The visual attraction stimulation image can be a minimum rectangular figure containing the target object 50, a figure obtained by enhancing the edge of the target object to outline the target object, a figure generated by adjusting a color parameter of the target object such as luminance, or the like. The visual attraction stimulation image can also be a minimum rectangular figure containing the target object or a figure generated by adjusting a color parameter such as luminance in regard to an image region surrounded by the edge of the target object when the edge is translated to the initial coordinates of the visual attraction stimulation image. The type of the visual attraction stimulation image is not particularly limited. However, the direction of the figure displayed as the visual attraction stimulation image is desired to be set to be in parallel with a surface containing the target object 50. Alternatively, the direction of the target object 50 may be set to be orthogonal to a vector heading from the initial coordinates of the visual attraction stimulation image towards the coordinates of the vehicle 10.

The visual attraction stimulation plan generated in the process step S303 includes a generation time T0, the initial coordinates of the visual attraction stimulation image, the moving speed S and the movement time T1 in regard to the movement of the visual attraction stimulation image towards the moving target object, the superimposition time T2 for which the visual attraction stimulation image is superimposed on the target object, a content type of the visual attraction stimulation image, and various parameters for determining the contents of the visual attraction stimulation.

By the completion of the generation of the visual attraction stimulation plan in FIG. 8, the process step S207 is completed and the visual attraction stimulation image generation unit 112 advances the process to process step S209.

In the process step S208 in FIG. 7, the visual attraction stimulation image generation unit 112 performs a visual attraction stimulation image correction process for the target object 50 for which the visual attraction stimulation plan has already been generated. In the process step S208, the visual attraction stimulation plan has already been generated, and thus the contents of the visual attraction stimulation plan are corrected to suit the situation at the present time point.

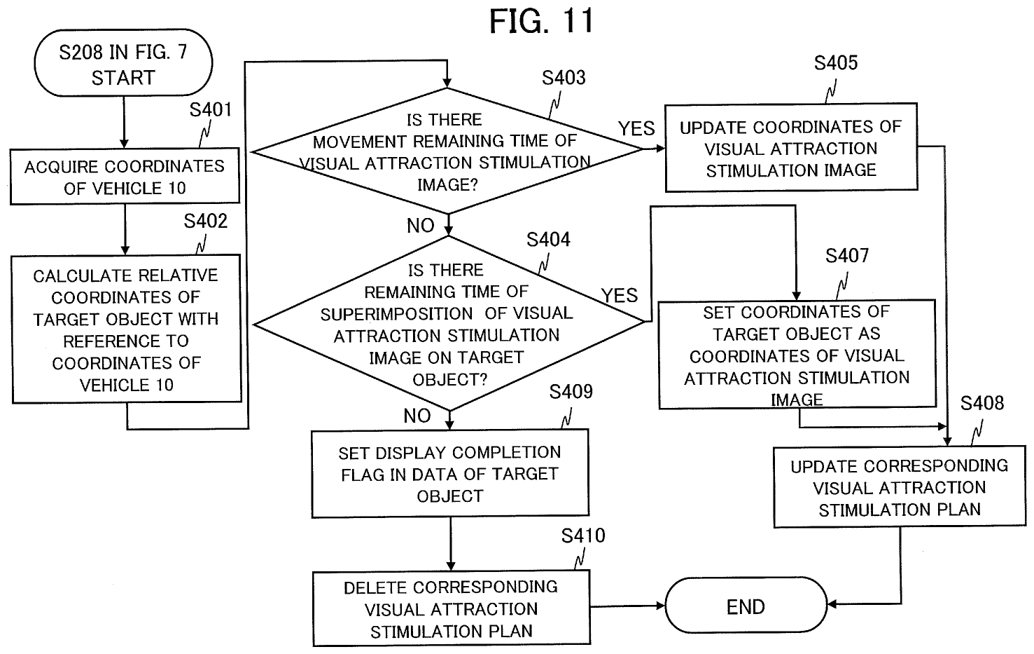

FIG. 11 is a flowchart showing the process step S208 as an existing visual attraction stimulation plan correction process performed by the visual attraction stimulation image generation unit 112.

Process step S401 is the same processing as the process step S301 in FIG. 8. Process step S402 is the same processing as the process step S302 in FIG. 8.

In process step S403, the visual attraction stimulation image generation unit 112 judges whether or not there is a remaining time in the movement time T1 of the movement of the visual attraction stimulation image towards the target object 50. Specifically, let T represent the present time, the visual attraction stimulation image generation unit 112 judges that there is a remaining time in the movement time T1 (YES in S403) and advances the process to process step S405 if a condition “T-T0<T1” is satisfied, or judges that there is no remaining time in the movement time T1 (NO in S403) and advances the process to process step S404 otherwise.

In the process step S404, the visual attraction stimulation image is already in the state of being in superimposition on the target object 50. In this case, the visual attraction stimulation image generation unit 112 judges whether or not there is a remaining time in the superimposition time T2 of the superimposition of the visual attraction stimulation image on the target object 50. Specifically, let T represent the present time, the visual attraction stimulation image generation unit 112 judges that there is a remaining time in the superimposition time T2 (YES in S404) and advances the process to process step S407 if a condition “T-T0<T1+T2” is satisfied, or judges that there is no remaining time in the superimposition time T2 (NO in S404) and advances the process to process step S409 otherwise.

In the process step S405, the visual attraction stimulation image is in a state of moving towards the target object 50 of the visual attraction stimulation image. At that time, the visual attraction stimulation image generation unit 112 calculates coordinates of the visual attraction stimulation image as coordinates where the visual attraction stimulation image at the present time point should exist. The method of calculating the coordinates of the visual attraction stimulation image is basically the same as the method of calculating the initial coordinates of the visual attraction stimulation image; however, “T1-(T-T0)” including the present time T is used for the calculation in place of the movement time T1. As the coordinates of the vehicle 10, it is also possible to directly use the coordinates used for determining the initial coordinates of the visual attraction stimulation image without recalculating the coordinates with reference to the present time. After calculating the coordinates of the visual attraction stimulation image, the visual attraction stimulation image generation unit 112 advances the process to process step S408.

In the process step S407, the visual attraction stimulation image is in the state of being in superimposition on the target object of the visual attraction stimulation image. In this case, the visual attraction stimulation image generation unit 112 calculates coordinates of the visual attraction stimulation image as coordinates where the visual attraction stimulation image at the present time point should exist. In the process step S407, the visual attraction stimulation image is in superimposition on the target object of the visual attraction stimulation image differently from the case of the process step S405, and thus the target object coordinates are used as the coordinates of the visual attraction stimulation image. After the calculation of the coordinates of the visual attraction stimulation image, the visual attraction stimulation image generation unit 112 advances the process to the process step S408.

In the process step S408, the visual attraction stimulation image generation unit 112 updates the visual attraction stimulation plan by using the coordinates of the visual attraction stimulation image calculated in the process step S405 or S407, renews the visual attraction stimulation plan in the memory 103, and ends the processing of the process step S208.

In the process step S404, when the superimposition time of the superimposition of the visual attraction stimulation image on the target object of the visual attraction stimulation image is over, the process advances to the process step S409. In this case, the visual attraction stimulation image generation unit 112 turns on the display completion flag in the target object data in order to stop the displaying of the visual attraction stimulation image.

In process step S410, the visual attraction stimulation image generation unit 112 deletes the visual attraction stimulation plan that has become unnecessary from the memory 103. After completion of the deletion, the processing of the process step S208 in FIG. 7 ends and the process advances to processing of the process step S209 in FIG. 7.

In the process step S209, the visual attraction stimulation image generation unit 112 records the visual attraction stimulation plan generated in the process step S207 or corrected in the process step S208 in the memory 103. After completing the recording, the visual attraction stimulation image generation unit 112 returns the process to the process step S201 and performs the process in regard to the next target object.

When there is no unprocessed target object in the process step S201, the process advances to the process step S210. The process step S210 is processing performed when the processing by the visual attraction stimulation image generation unit 112 for the target objects in the current forward image is completed, in which the visual attraction stimulation frame for displaying the visual attraction stimulation images is generated based on all the visual attraction stimulation plans.

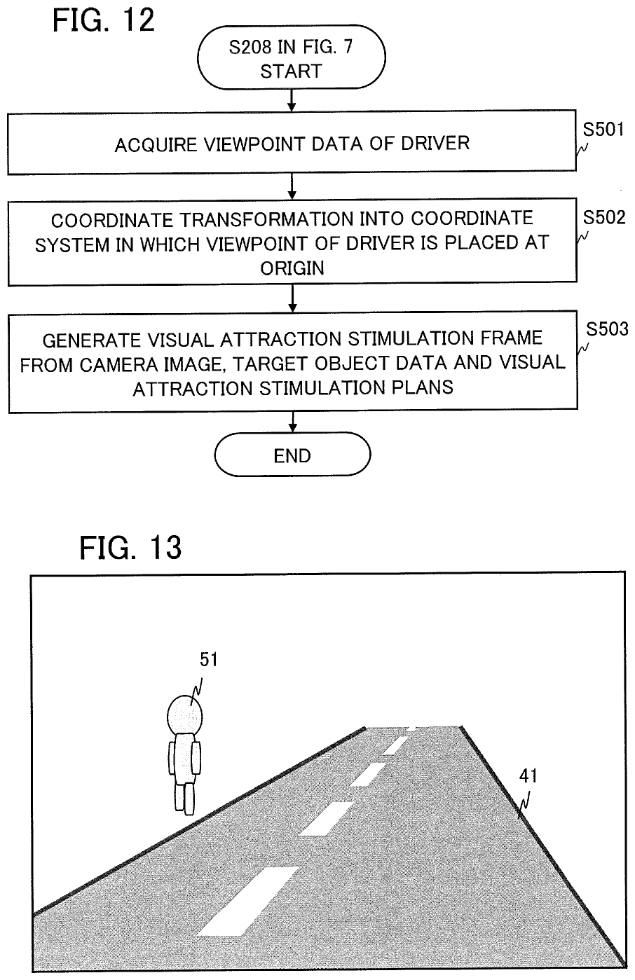

FIG. 12 is a flowchart showing the process step S210 as a visual attraction stimulation frame generation process performed by the visual attraction stimulation image generation unit 112.

In process step S501, the visual attraction stimulation image generation unit 112 acquires the viewpoint coordinates of the driver 30 from the viewpoint sensor 106. In process step S502, the visual attraction stimulation image generation unit 112 transforms the coordinate system used in the processing so far into a coordinate system in which the viewpoint coordinates of the driver 30 acquired in the process step S501 is placed at the origin. In process step S503, the visual attraction stimulation image generation unit 112 generates the visual attraction stimulation frame including one or more visual attraction stimulation images to be actually presented visually, by using data of the transformed coordinate system, and transfers the generated visual attraction stimulation frame to the display control unit 113.

The display control unit 113 successively provides the display device 107 with the visual attraction stimulation frames generated by the visual attraction stimulation image generation unit 112 and thereby makes the display device 107 display the visual attraction stimulation frames to the driver 30.

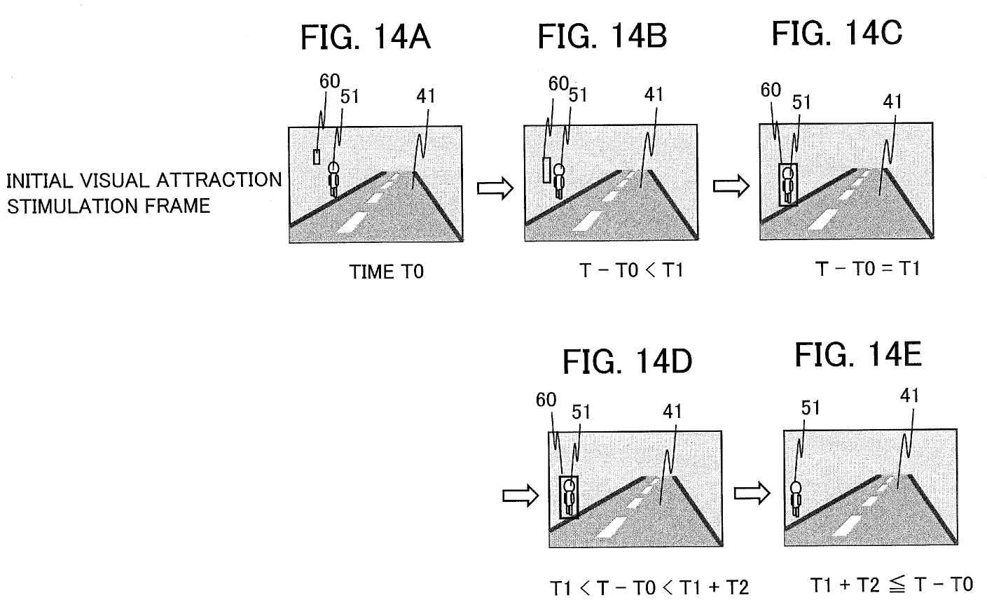

FIG. 13 is a diagram showing an example of a forward image in which a pedestrian 51 as a target object is walking on a sidewalk on the left-hand side of a road and the vehicle 10 is traveling on a right-hand lane of a roadway 41. FIGS. 14A to 14E, FIGS. 15A to 15E and FIGS. 16A to 16E show display examples of the visual attraction stimulation image when the forward image shown in FIG. 13 is acquired.

FIGS. 14A to 14E, FIGS. 15A to 15E and FIGS. 16A to 16E show the visual attraction stimulation images 60, 61 and 62 presented by the display device 107 and forward scenes that the driver 30 is viewing at certain times.

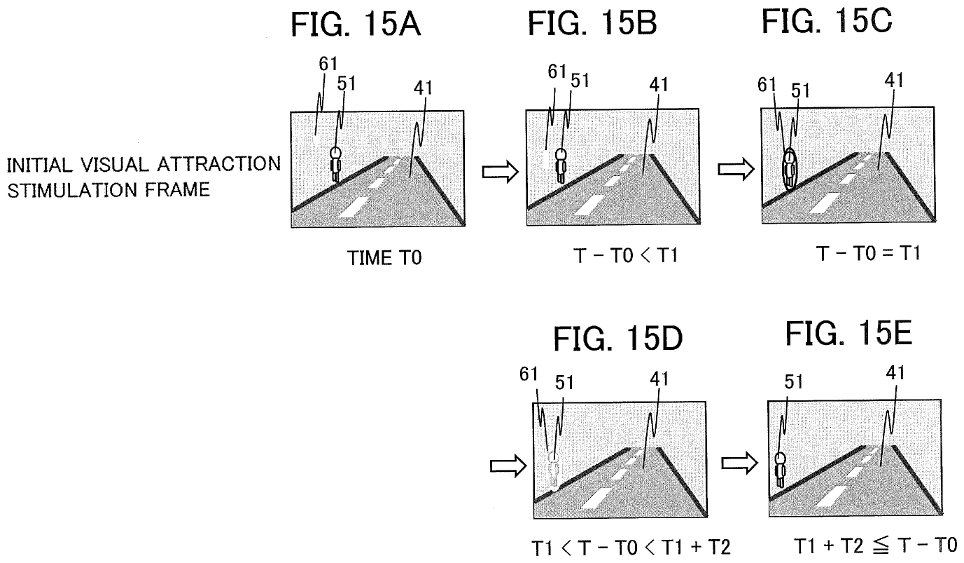

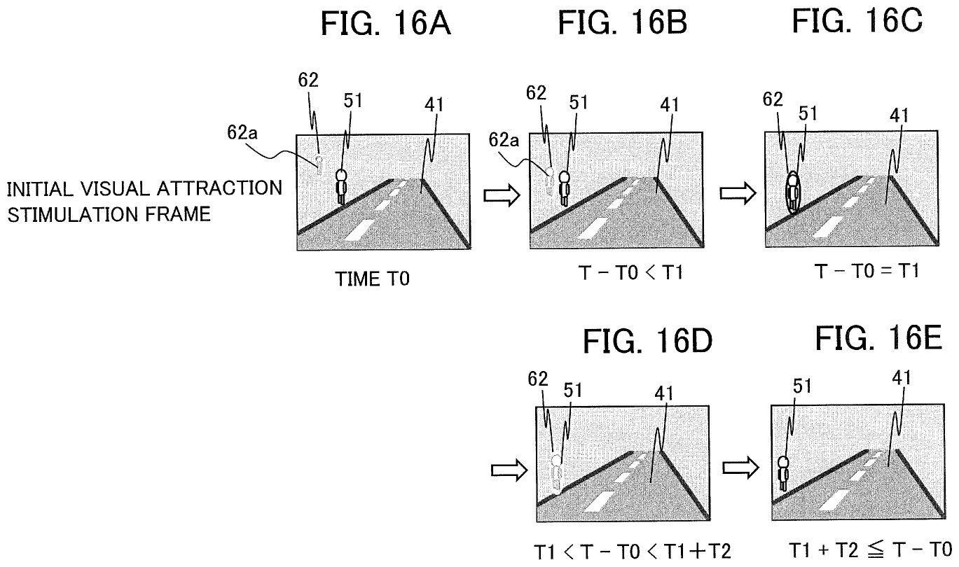

FIG. 14A, FIG. 15A and FIG. 16A show the forward scene and the visual attraction stimulation images 60, 61 and 62 at the time point when the initial coordinates of the visual attraction stimulation images 60, 61 and 62 have been calculated.

FIG. 14B, FIG. 15B and FIG. 16B show the forward scene and the moving visual attraction stimulation images 60, 61 and 62 at a time when T-T0<T1 is satisfied.

FIG. 14C, FIG. 15C and FIG. 16C show the forward scene and the visual attraction stimulation images 60, 61 and 62 that have reached the target object 51 at a time when T-T0=T1 is satisfied.

FIG. 14D, FIG. 15D and FIG. 16D show the forward scene and the visual attraction stimulation images 60, 61 and 62 in superimposition on the target object 51 at a time when T1<T-T0<T1+T2 is satisfied.

FIG. 14E, FIG. 15E and FIG. 16E show the forward scene at a time when T1+T2≤T-T1 is satisfied. At that time, the visual attraction stimulation images 60, 61 and 62 are not displayed.

FIGS. 14A to 14E show a concrete example of a case where the visual attraction stimulation image 60 is generated as a minimum rectangle containing the target object. At the time point of FIG. 14A when the initial coordinates of the visual attraction stimulation image have been calculated, the visual attraction stimulation image 60 is displayed farther than and further outside than the pedestrian 51. In FIG. 14B, the visual attraction stimulation image 60 is displayed closer to the present position of the pedestrian 51 with the passage of time, and the visual attraction stimulation image 60 is superimposed on the pedestrian 51 at the time point of FIG. 14C when the movement time T1 elapses. From that time point until the superimposition time T2 elapses, the visual attraction stimulation image 60 is displayed as shown in FIG. 14D in superimposition on the pedestrian 51 according to the present position of the pedestrian 51, and the visual attraction stimulation image disappears as shown in FIG. 14E when the superimposition time T2 elapses.

FIGS. 15A to 15E show a concrete example of a case where the visual attraction stimulation image 61 is a figure generated by adjusting a color parameter such as luminance in regard to an image region surrounded by the edge of the target object translated to the coordinates of the visual attraction stimulation image 61. The states at the times in FIGS. 15A to 15E are the same as those in FIGS. 14A to 14E. The example of FIGS. 15A to 15E differs from the example of FIGS. 14A to 14E in that conspicuity of the image existing in the region for displaying the visual attraction stimulation image is increased to be more visually noticeable. Thus, upon reaching the time point of FIG. 15C, the visual attraction stimulation image 61 contains the whole of the pedestrian 51.

FIGS. 16A to 16E show a concrete example of a case where the visual attraction stimulation image 62 is a figure generated by adjusting a color parameter of the target object such as luminance. The states at the times in FIGS. 16A to 16E are the same as those in FIGS. 14A to 14E. In the example of FIGS. 16A to 16E, the visual attraction stimulation image 62 is a stimulus generated based on an image of the pedestrian 51 by performing image processing for increasing the conspicuity, and thus contents as a target object FIG. 62a corresponding to the pedestrian 51 are contained in the visual attraction stimulation image 62 even at the time points of FIGS. 16A and 16B differently from the above-described examples.

Irrespective of the type of the visual attraction stimulation image, each visual attraction stimulation image 60, 61, 62 in FIGS. 14A to 14E, FIGS. 15A to 15E and FIGS. 16A to 16E works as a stimulus that gradually approaches the vehicle 10. Accordingly, risk awareness of the danger of collision of something with the vehicle 10 occurs to the driver 30. Further, for the driver 30, the visual attraction stimulation image is a stimulus that does not approach the vehicle 10 further than the actual target object 50 after the time point of FIG. 14C, FIG. 15C and FIG. 16C, which makes it possible to avoid causing excessive awareness stronger than awareness of danger occurring in the real world.

### (3) Effect

With the driving support device 100 according to this embodiment, the line of sight of the driver 30 of the vehicle 10 can be guided to the target object 50 (e.g., pedestrian 51) by use of the visual attraction stimulation image 60-62.

Further, with the driving support device 100 according to this embodiment, the driver 30 is enabled to have the awareness of the danger of collision in a simulation-like manner thanks to the visual attraction stimulation image 60-62 moving towards the target object 50 from a position farther than the target object 50, that is, the visual attraction stimulation image 60-62 approaching the vehicle 10. Accordingly, it is possible to prevent the decrease in the consciousness of the driver 30 trying to perceive the target object with the driver's own attentiveness. In other words, with the driving support device 100 according to this embodiment, the driver 30 driving the vehicle 10 experiences the approach of the target object in a simulation-like manner thanks to the visual attraction stimulation image 60-62, which makes the driver 30 have consciousness of autonomously inhibiting a decrease in safety awareness.

Furthermore, with the driving support device 100 according to this embodiment, the movement time T1 until showing the enhanced display of the target object is set, which makes it possible to prevent the driver 30 from having excessive risk awareness due to intense stimulation.

Moreover, with the driving support device 100 according to this embodiment, the superimposition time T2 for which the visual attraction stimulation image 60-62 is displayed in superimposition on the target object is set, and thus the visual attraction stimulation image 60-62 disappears at or just after the moment when the driver 30 actually responds to the visual attraction stimulation image 60-62 and moves the line of sight. Accordingly, the driver 30 just after moving the line of sight mainly views the target object 50 alone, which also brings an advantage of not giving a feeling of strangeness to the driver 30.

### DESCRIPTION OF REFERENCE CHARACTERS

10: vehicle, 22: windshield, 30: driver, 40: road, 41: roadway, 50: target object, 51: pedestrian (target object), 60, 61, 62: visual attraction stimulation image, 100: driving support device, 101: control unit, 102: processor, 103: memory, 104: image processing processor, 105: camera (vicinity detection unit), 106: viewpoint sensor, 107: display device, 111: target object judgment unit, 112: visual attraction stimulation image generation unit, 113: display control unit.

What is claimed is:

1. A driving support device for supporting driving performed by a driver of a vehicle, comprising:
processing circuitry
to judge a target object that is a real object existing in a vicinity of the vehicle and should be paid attention to by the driver, based on vicinity information acquired by a vicinity detector that captures an image of or detects a real object existing in the vicinity of the vehicle;
to generate a visual attraction stimulation image that appears to move from a position farther than the target object towards a position where the target object exists; and
to cause a display device that displays an image in superimposition on the real object to display the visual attraction stimulation image,
wherein the processing circuitry sets a direction of a movement vector of the visual attraction stimulation image in regard to a time of determining the position of starting the movement of the visual attraction stimulation image at a direction heading towards a position of the vehicle.

2. The driving support device according to claim 1, wherein the processing circuitry starts the movement of the visual attraction stimulation image at the position farther than the target object and ends the movement of the visual attraction stimulation image at the position where the target object exists.

3. The driving support device according to claim 1, wherein the processing circuitry starts the movement of the visual attraction stimulation image at the position farther than the target object, moves the visual attraction stimulation image to the position where the target object exists, and thereafter updates the position of the visual attraction stimulation image in synchronization with movement of the target object.

4. The driving support device according to claim 1, wherein
when a plurality of target objects is judged to exist, the processing circuitry determines priority of each of the plurality of target objects and obtains a target object determined among the plurality of target objects based on the priority, and
the processing circuitry generates the visual attraction stimulation image for the obtained target object.

5. The driving support device according to claim 1, wherein the position of the vehicle is the position of the vehicle at a present time point or an expected position where the vehicle is expected to exist at a time point after passage of a predetermined certain time after the present time point.

6. The driving support device according to claim 1, wherein the processing circuitry determines a movement time taken to move the visual attraction stimulation image from initial coordinates to endpoint coordinates based on a human's visual reaction speed.

7. The driving support device according to claim 1, wherein the processing circuitry sets a surface of the visual attraction stimulation image to be in parallel with a surface containing the target object or to be orthogonal to a vector heading from initial coordinates of the visual attraction stimulation image towards a position of the vehicle.

8. A driving support method of supporting driving performed by a driver of a vehicle, comprising:
judging a target object that is a real object existing in a vicinity of the vehicle and should be paid attention to by the driver, based on vicinity information acquired by a vicinity detector that captures an image of or detects a real object existing in the vicinity of the vehicle;
generating a visual attraction stimulation image that appears to move from a position farther than the target object towards a position where the target object exists;
setting a direction of a movement vector of the visual attraction stimulation image in regard to a time of determining the position of starting the movement of the visual attraction stimulation image at a direction heading towards a position of the vehicle; and
causing a display device that displays an image in superimposition on the real object to display the visual attraction stimulation image.

9. A non-transitory computer-readable storage medium storing a driving support program for supporting driving performed by a driver of a vehicle, the driving support program causing a computer to execute processing comprising:
judging a target object that is a real object existing in a vicinity of the vehicle and should be paid attention to by the driver, based on vicinity information acquired by a vicinity detector that captures an image of or detects a real object existing in the vicinity of the vehicle;
generating a visual attraction stimulation image that appears to move from a position farther than the target object towards a position where the target object exists;
setting a direction of a movement vector of the visual attraction stimulation image in regard to a time of determining the position of starting the movement of the visual attraction stimulation image at a direction heading towards a position of the vehicle; and
causing a display device that displays an image in superimposition on the real object to display the visual attraction stimulation image.
